(19) United States
(12) Patent Application Publication
(10) Pub. No.: US 2026/0213358 A1
(43) Pub. Date: Jul. 23, 2026

(54) BATTERY PACK

(71) Applicant: TOYOTA JIDOSHA KABUSHIKI KAISHA, Toyota-shi (JP)

(72) Inventor: Shigeyuki MORI, Nagoya-shi (JP)

(73) Assignee: TOYOTA JIDOSHA KABUSHIKI KAISHA, Toyota-shi (JP)

(21) Appl. No.: 19/434,602

(22) Filed: Dec. 29, 2025

(30) Foreign Application Priority Data
Jan. 21, 2025 (JP) 2025-008674

(51) Int. Cl. H01M 50/507; H01M 50/204; H01M 50/249; H01M 50/296; H01M 50/51

(52) U.S. Cl. CPC H01M 50/507; H01M 50/249; H01M 50/296; H01M 50/51; H01M 50/204

(57) ABSTRACT

A battery pack includes: a plurality of battery stacks, each of the plurality of battery stacks including a plurality of battery cells stacked in a first direction; a case configured to house the battery stack; and a plurality of busbars configured to electrically connect the plurality of battery cells to each other. Th plurality of the battery stacks are arranged in a second direction perpendicular to the first direction in the case. The plurality of busbars include a first busbar arranged to span between the battery stacks adjacent to each other in the second direction and connected to terminals of the battery cells included in different battery stacks so as to electrically connect the battery cells included in the different battery stacks. The plurality of battery cells arranged in the second direction at a same position in the first direction are electrically connected in series by the first busbar.

The present application claims priority to and incorporates by reference the entire contents of Japanese Patent Application No. 2025-008674 filed in Japan on Jan. 21, 2025.

### BACKGROUND

The present disclosure relates to a battery pack.

JP2023074270A discloses a battery module including multiple stacked battery cells, wherein adjacent battery cells in the stacking direction are electrically connected by a busbar, thereby electrically connecting all battery cells in series at the battery module level.

### SUMMARY

In the configuration described in JP2023074270A, a pair of common terminals is provided per battery module. Therefore, in a battery pack comprising multiple such battery modules, it is conceivable to electrically connect the multiple battery modules by connecting the common terminals of different battery modules via a busbar. In this case, the busbars connected to the terminals become long, and space must be secured within the case to accommodate these busbars, leading to a larger battery pack.

There is a need for a battery pack that can be miniaturized by reducing the space required to accommodate busbars within the case.

According to one aspect of the present disclosure, there is provided a battery pack including: a plurality of battery stacks, each of the plurality of battery stacks including a plurality of battery cells stacked in a first direction; a case configured to house the battery stack; and a plurality of busbars configured to electrically connect the plurality of battery cells to each other, wherein the plurality of the battery stacks are arranged in a second direction perpendicular to the first direction in the case, the plurality of busbars include a first busbar arranged to span between the battery stacks adjacent to each other in the second direction and connected to terminals of the battery cells included in different battery stacks so as to electrically connect the battery cells included in the different battery stacks, and the plurality of battery cells arranged in the second direction at a same position in the first direction are electrically connected in series by the first busbar.

### BRIEF DESCRIPTION OF THE DRAWINGS

FIG. 1 schematically illustrates a battery pack according to an embodiment;

FIG. 2 illustrates a state where multiple battery stacks are housed inside the case;

FIG. 3 illustrates the high-voltage line formed by the battery pack;

FIG. 4 schematically illustrates a battery pack of a comparative example; and

FIG. 5 is a diagram illustrating the high-voltage line formed in the battery pack of the comparative example.

### DETAILED DESCRIPTION

The battery pack of an embodiment of the present disclosure will now be described in detail. Note that the present disclosure is not limited to the embodiment described below.

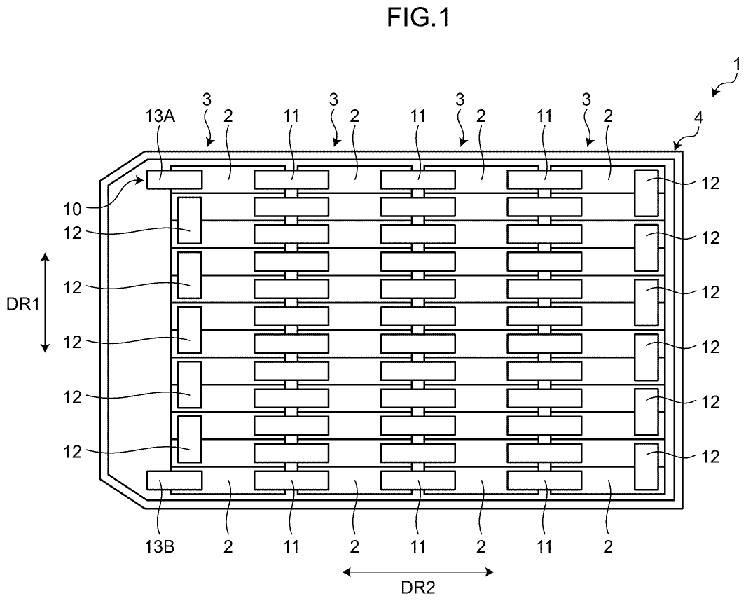

FIG. 1 schematically shows a battery pack according to an embodiment. The battery pack 1 is installed in electric vehicles such as hybrid vehicles and electric vehicles. The battery pack 1 comprises a battery stack 3 formed by stacking a plurality of battery cells 2 and a case 4 that accommodates the battery stack 3.

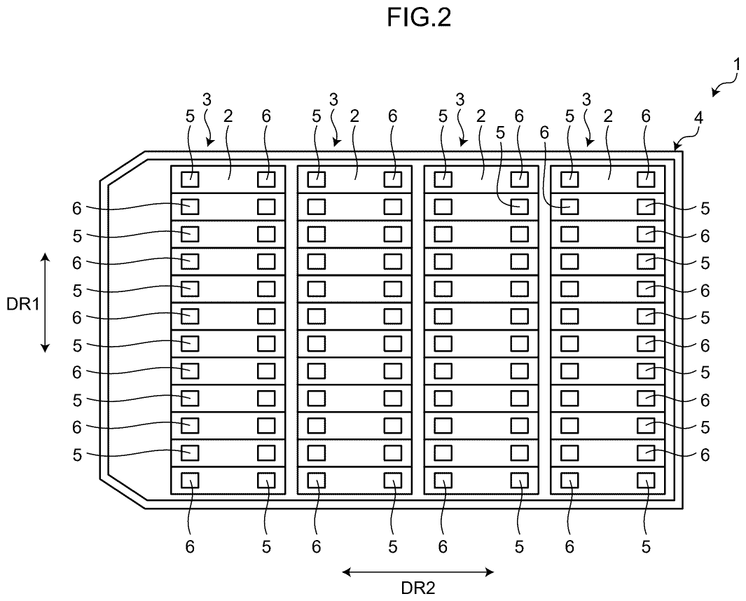

Within the battery pack 1, multiple battery stacks 3 are housed inside the case 4. As shown in FIG. 2, the battery stack 3 is a laminated structure formed by stacking multiple battery cells 2. That is, the battery stack 3 represents a laminated structure where multiple battery cells 2 are not electrically connected by a bus bar 10. When multiple battery cells 2 are electrically connected by a bus bar 10, it is referred to as a battery module. Battery stack 3 has a structure where multiple battery cells 2 are stacked in a first direction DR1. The first direction DR1 is the same direction as the stacking direction in which multiple battery cells 2 are stacked.

Inside case 4, multiple battery stacks 3 are arranged side by side in a second direction DR2. The second direction DR2 is perpendicular to the first direction DR1. As shown in FIGS. 1 and 2, in the embodiment, four battery stacks 3 are housed inside the case 4. When the battery pack 1 is installed in a vehicle, the first direction DR1 is in the same direction as the vehicle width direction, and the second direction DR2 is in the same direction as the vehicle front-to-rear direction.

The battery pack 1 includes multiple busbars 10 that electrically connect the battery cells 2 to each other. The multiple busbars 10 are positioned above the battery cells 2 inside the case 4. The multiple busbars 10 comprise three types of busbars differing in shape and function: a first busbar 11, a second busbar 12, and a third busbar 13.

The first busbar 11 extends along a direction perpendicular to the stacking direction of the battery cells 2 (the second direction DR2) and electrically connects adjacent battery cells 2 in the second direction DR2. The first busbar 11 electrically connects different battery stacks 3, connecting battery cells 2 contained within different battery stacks 3. As shown in FIG. 1, the first busbar 11 is arranged to span between battery stacks 3 adjacent in the second direction DR2 and is connected to terminals of battery cells 2 adjacent in the second direction DR2. All multiple first busbars 11 are formed with the same shape. Furthermore, all battery cells 2 included in the battery pack 1 have at least one terminal connected to the first busbar 11. Multiple battery cells 2 arranged side by side in the second direction DR2 at the same position in the first direction DR1 within the case 4 are electrically connected in series by the first busbar 11.

The second busbar 12 extends along the stacking direction (first direction DR1) of the battery cells 2 and electrically connects battery cells 2 adjacent to each other in the first direction DR1. The second busbar 12 is connected to the terminals of battery cells 2 adjacent to each other in the first direction DR1, electrically connecting battery cells 2 within the same battery stack 3. All multiple second busbars 12 are formed with the same shape.

The third busbar 13 is a busbar connected to the battery stack 3 positioned at one end of the second direction DR2, functioning as a terminal for the battery pack 1. The terminals of the battery pack 1 connect the battery pack, consisting of a group of battery cells 2, to external equipment. The external equipment includes electrical devices located within the case 4 on one side of the battery stack 3 relative to the second direction DR2. The terminals of the battery cells 2 to which the third bus bar 13 is connected are terminals positioned on one end side of the second direction DR2.

The third busbar 13 includes a total positive busbar 13A, which functions as the total positive terminal of the battery pack 1, and a total negative busbar 13B, which functions as the total negative terminal of the battery pack 1. The total positive busbar 13A and the total negative busbar 13B are connected to the same battery stack 3. The total positive busbar 13A and the total negative busbar 13B extend along the second direction DR2 toward one side of the second direction DR2 relative to their respective battery stack 3. The total positive busbar 31 and the total negative busbar 32 are formed with the same shape.

The total positive busbar 13A is connected to the positive terminal 5 of a battery cell 2 positioned at one end of the stacking direction (first direction DR1) among the battery stacks 3 arranged at one end of the second direction DR2. The positive terminal to which the total positive busbar 13A is connected is the positive terminal 5 positioned at one end of the second direction DR2 and at one end of the first direction DR1.

The common negative busbar 13B is connected to the negative terminal 6 of the battery cell 2 positioned at the other end in the stacking direction (first direction DR1) within the battery stack 3 arranged at one end of the second direction DR2. The negative terminal connected to the common negative busbar 13B is the negative terminal 6 positioned at one end of the second direction DR2 and at the other end of the first direction DR1.

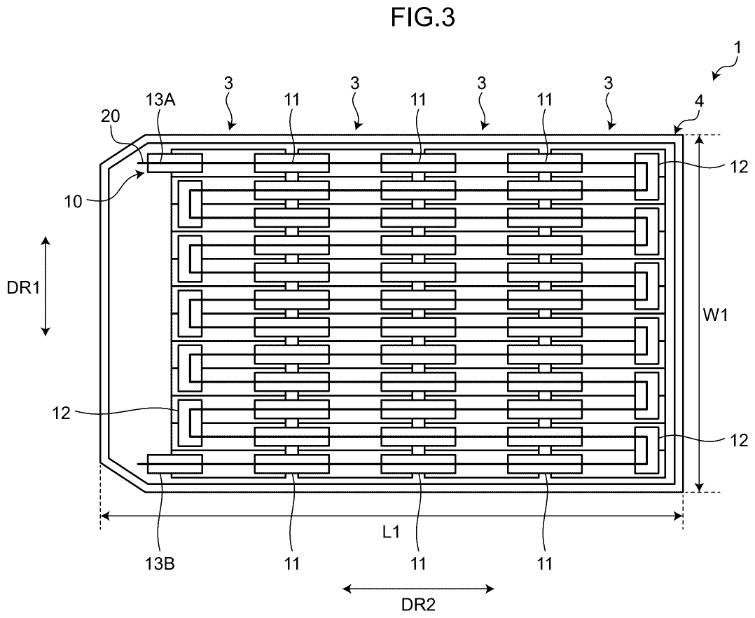

As shown in FIG. 3, the high-voltage line 20 in the battery pack 1 is formed such that it crosses the multiple battery stacks 3 in the second direction DR2. The high-voltage line 20 is formed such that it loops back in the second direction DR2 between the battery stacks 3 positioned at both ends of the second direction DR2, by electrically connecting battery cells 2 contained in different battery stacks 3 via the first busbar 11. Furthermore, since the total positive bus bar 13A and the total negative bus bar 13B are connected to the battery stack 3 positioned at one end of the second direction DR2, the third bus bars 13 serving as the total positive and total negative terminals can be drawn out from the battery stack 3 located closer to the external equipment.

In the battery pack 1 configured in this manner, since the bus bars 10 are not positioned outside the battery stacks 3 on both sides of the first direction DR1, the space required for positioning the bus bars 10 can be reduced, allowing the first direction length W1 of the case 4 to be shortened. Similarly, in the battery pack 1, since the busbar 10 is not positioned outside the battery stack 3 on the opposite end side in the second direction DR2, the second direction length L1 of the case 4 can be shortened. According to the battery pack 1, the component shape of the busbar 10 can be unified into three types, and the case 4 can be made more space-efficient. This allows the size of the case 4 to be reduced, enabling miniaturization of the battery pack 1. Furthermore, since the battery pack 1 eliminates the need for long busbars, the electrical resistance caused by the busbar 10 can be reduced.

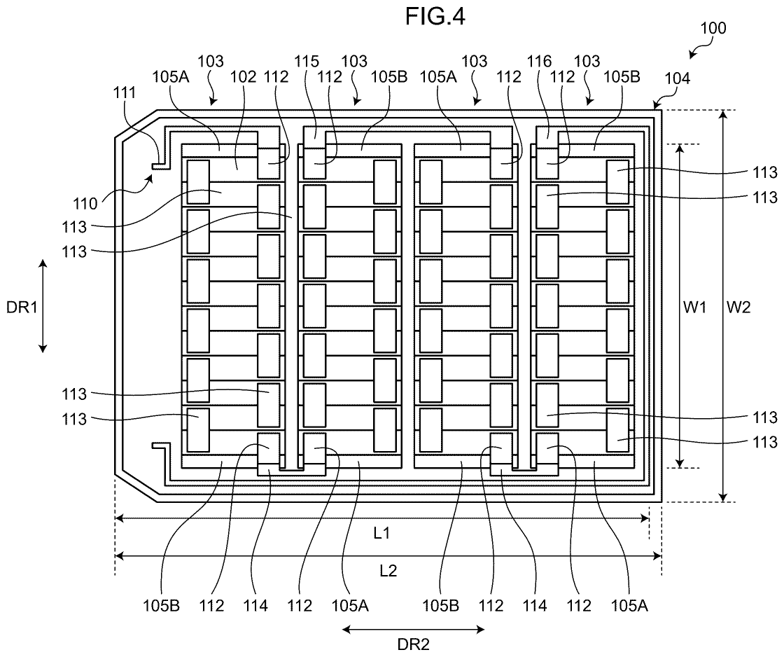

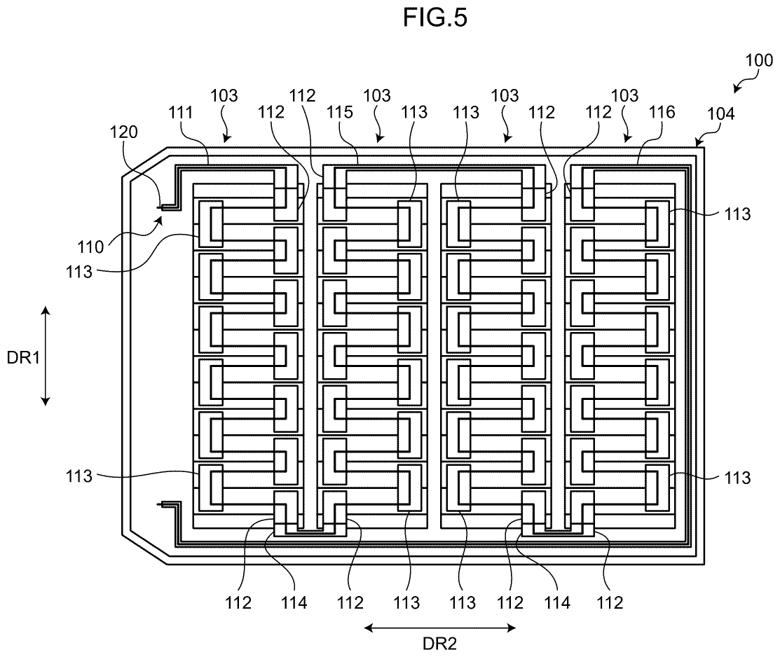

As shown in FIGS. 4 and 5, the comparative example battery pack 100 includes multiple busbars 110 that electrically connect multiple battery cells 102. The multiple busbars 110 include six types of busbars with different shapes: a first busbar 111, a second busbar 112, a third busbar 113, a fourth busbar 114, a fifth busbar 115, and a sixth busbar 116.

The first busbar 111 is a common negative busbar functioning as a terminal for the battery pack 100. The first busbar 111 is connected to the terminal block of the end plate 105A and connects to the negative terminals of the battery cells 102 via the terminal block of the end plate 105A and the second busbar 112. The battery module to which the first busbar 111 is connected is the battery module 103 positioned at one end of the second direction DR2. The negative terminal to which the first busbar 111 is connected is not the terminal positioned at one end of the second direction DR2. The first busbar 111 is a long busbar positioned outwardly relative to the battery module 103 in the first direction DR1.

The second busbar 112 is a busbar functioning as a terminal for the battery module 103. The second busbar 112 extends outward beyond the battery cell 102 in the first direction DR1. The second busbar 112 includes a negative busbar connected to the negative terminal of the battery cell 102 and the terminal block of the end plate 105A, and a positive busbar connected to the positive terminal of the battery cell 102 and the terminal block of the end plate 105B.

The third busbar 113 electrically connects adjacent battery cells 102 in the stacking direction. The battery module 103 is a unit with the second busbar 112 and third busbar 113 installed before being housed in the case 104. The first busbar 111, fourth busbar 114, fifth busbar 115, and sixth busbar 116 are installed on the battery module 103 after it is housed in the case 104.

The fourth busbar 114 electrically connects adjacent battery modules 103 in the second direction DR2 and also connects adjacent second busbars 112 in the second direction DR2. The fourth busbar 114 connects adjacent positive busbars and negative busbars in the second direction DR2. The fourth busbar 114 is a long busbar positioned outward from the battery modules 103 in the first direction DR1.

The fifth busbar 115 electrically connects battery modules 103 adjacent to each other in the second direction DR2 and also connects second busbars 112 located apart from each other in the second direction DR2. The fifth bus bar 115 connects the positive bus bars and negative bus bars positioned apart in the second direction DR2. The fifth bus bar 115 is a long bus bar positioned outward from the battery module 103 in the first direction DR1.

The sixth busbar 116 is a total positive busbar functioning as a terminal for the battery pack 100. The sixth busbar 116 is connected to the terminal block of the end plate 105B and connects to the positive terminal of the battery cell 102 via the terminal block of the end plate 105B and the second busbar 112. The battery module to which the sixth bus bar 116 is connected is the battery module 103 positioned on the opposite end of the second direction DR2. The positive terminal to which the sixth bus bar 116 is connected is not the terminal positioned on one end of the second direction DR2. The sixth busbar 116 is a long busbar positioned outward from the battery module 103 in both the first direction DR1 and the second direction DR2.

As shown in FIG. 5, the high-voltage line 120 in the battery pack 100 is formed to electrically connect multiple battery cells 102 in series within each battery module 103 unit. As shown in FIG. 4, the case 104 has space in the first direction DR1 and the second direction DR2 to accommodate the first busbar 111, the fourth busbar 114, the fifth busbar 115, and the sixth busbar 116, all positioned outside the battery module 103. The case 104 is formed with a first direction length W2 and a second direction length L2. The first direction length W2 is greater than the first direction length W1 of the case 4. The second direction length L2 is greater than the second direction length L2 of case 4. That is, case 104 is larger than case 4. Specifically, in battery pack 1, the first direction length W1 of case 4 is shorter than the first direction length W2 of case 104 in the comparative example, and the second direction length L1 of case 4 is shorter than the second direction length L2 of case 104 in the comparative example.

In the battery pack 1 of the embodiment, long busbars such as the first busbar 111, fourth busbar 114, fifth busbar 115, and sixth busbar 116 in the comparative example can be eliminated. Therefore, the multiple busbars 10 are composed of busbars shorter than the first busbar 111, fourth busbar 114, fifth busbar 115, and sixth busbar 116 in the comparative example, resulting in lower resistance for the busbars 10. This reduces energy loss in the busbars 10 during energization.

As described above, according to the embodiment, it is possible to save space in case 4 and reduce the electrical resistance of the busbar 10.

The present disclosure reduces the space required for busbar placement within the case, enabling miniaturization of the battery pack.

Although the disclosure has been described with respect to the specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A battery pack comprising:
a plurality of battery stacks, each of the plurality of battery stacks including a plurality of battery cells stacked in a first direction;
a case configured to house the battery stack; and
a plurality of busbars configured to electrically connect the plurality of battery cells to each other,
wherein the plurality of the battery stacks are arranged in a second direction perpendicular to the first direction in the case,
the plurality of busbars include a first busbar arranged to span between the battery stacks adjacent to each other in the second direction and connected to terminals of the battery cells included in different battery stacks so as to electrically connect the battery cells included in the different battery stacks, and
the plurality of battery cells arranged in the second direction at a same position in the first direction are electrically connected in series by the first busbar.

2. The battery pack according to claim 1, wherein the first busbar is positioned above the plurality of battery cells and extends along the second direction.

3. The battery pack according to claim 1, wherein each of the plurality of battery cells has at least one terminal connected to the first busbar.

4. The battery pack according to claim 3, wherein
the plurality of busbars include:
a second busbar configured to electrically connect adjacent battery cells in the first direction; and
a third busbar connected to the battery stack positioned at one end in the second direction and configured to function as a terminal of the battery pack,
the third busbar includes:
a total positive busbar connected to a terminal of the battery cell arranged at one end of the first direction, and
a total negative busbar connected to a terminal of the battery cell arranged at an other end of the first direction.

5. The battery pack according to claim 4, wherein
the terminal to which the third busbar is connected is positioned at the one end of the second direction, and
the third busbar extends along the second direction.
